(19) United States
(12) Patent Application Publication
(10) Pub. No.: US 2024/0430613 A1
(43) Pub. Date: Dec. 26, 2024

(54) ACOUSTIC OUTPUT DEVICE

(71) Applicant: SAMSUNG ELECTRONICS CO., LTD., Suwon-si (KR)

(72) Inventors: Euihan YOON, Suwon-si (KR); Taemyun Kim, Suwon-si (KR)

(73) Assignee: SAMSUNG ELECTRONICS CO., LTD., Suwon-si (KR)

(21) Appl. No.: 18/827,296

(22) Filed: Sep. 6, 2024

Related U.S. Application Data
(63) Continuation of application No. PCT/KR2023/003176, filed on Mar. 8, 2023.

(30) Foreign Application Priority Data
Apr. 26, 2022 (KR) 10-2022-0051616

(51) Int. Cl. H04R 1/28; G10K 11/16

(52) U.S. Cl. CPC H04R 1/2873; G10K 11/16

(57) ABSTRACT

An acoustic output device includes: an enclosure; a speaker driver arranged inside and fixed by the enclosure and comprising a vibration plate exposed to a front surface of the enclosure, the vibration plate being configured to generate sounds; and a filter arranged between a rear surface of the speaker driver and an inner surface of the enclosure. The filter may be distanced from the inner surface of the enclosure and include a plurality of through holes.

### CROSS-REFERENCE TO RELATED APPLICATIONS

This application is a continuation of International Application No. PCT/KR2023/003176, filed on Mar. 8, 2023, which is based on and claims priority to Korean Patent Application No. 10-2022-0051616, filed on Apr. 26, 2022, in the Korean Intellectual Property Office, the disclosures of which are incorporated by reference herein in their entireties.

### BACKGROUND

### 1. Field

The disclosure relates to an acoustic output device, and more particularly, to an acoustic output device including a structure for removing a standing wave that is generated inside the acoustic output device.

### 2. Description of the Related Art

In the case of a flat panel display device such as an LCD television (TV), an LED TV, a quantum dot TV, an OLED TV, a monitor, etc., as the thickness of the device becomes gradually thinner, the performance of a built-in speaker provided in the flat panel display device becomes limited.

Recently, for resolving such limitation of the performance of a built-in speaker, a sound bar is being widely used together with a thin type flat panel display device.

Meanwhile, a standing wave is generated if a sound wave generated in a speaker driver of a sound bar is reflected from the inside of an enclosure and interferes with a sound wave proceeding to the outside of the enclosure. This causes the quality of a sound reproduced by the sound bar is reduced.

In the past, a reflected wave was absorbed by arranging a sound absorbing material inside a sound bar for removing such standing wave. However, in the case of using a sound absorbing material, there was a problem that heat generated inside the enclosure could not be discharged to the outside smoothly.

### SUMMARY

Additional aspects will be set forth in part in the description which follows and, in part, will be apparent from the description, or may be learned by practice of the presented embodiments.

Provided is an acoustic output device wherein a filter member, on which a plurality of through holes are formed, is installed inside an enclosure to improve the standing wave removing performance, and heat can be discharged smoothly and the stiffness of the enclosure can be reinforced.

According to an aspect of the disclosure, acoustic output device includes: an enclosure; a speaker driver arranged inside and fixed by the enclosure and comprising a vibration plate exposed to a front surface of the enclosure, the vibration plate being configured to generate sounds; and a filter arranged between a rear surface of the speaker driver and an inner surface of the enclosure. The filter may be distanced from the inner surface of the enclosure and include a plurality of through holes. The filter may include a first filter and a second filter sequentially arranged between the rear surface of the speaker driver and the inner surface of the enclosure. Each of the first filter and the second filter may respectively include a plurality of through holes.

At least one of a shape or an arrangement of the plurality of through holes of the first filter and the second filter may be different.

The plurality of through holes may have a shape of at least one shape of a circle, an oval, a polygon, or a polygon having round edges.

The plurality of through holes may be arranged in a matrix form.

The enclosure may be hollow and have a rectangular shape, and an upper part and a lower part of the filter may be fixed to the inner surface of the enclosure.

The filter may include a plate shape on which the plurality of through holes are formed, and the plurality of through holes may penetrate a front surface and a rear surface of the filter.

The filter may have a size corresponding to the rear surface of the speaker driver.

The acoustic output device may further include a sound absorbing material on one surface of the filter.

A distance between the filter and the inner surface of the enclosure may be based on a distance between the rear surface of the speaker driver and the inner surface of the enclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a perspective view illustrating an acoustic output device according to some embodiments of the disclosure;

FIG. 2 is a cross-sectional view that is cut along II-II in FIG. 1;

FIG. 3 through FIG. 6 are diagrams illustrating various embodiments related to shapes and an arrangement form of a plurality of through holes formed on a filter member;

FIG. 7 is a diagram illustrating an acoustic output device wherein two filter members are arranged according to some embodiments of the disclosure;

FIG. 8 is a diagram illustrating an acoustic output device wherein a filter and a sound absorbing material are arranged according to some embodiments of the disclosure; and

FIG. 9 is a diagram illustrating a structure wherein a filter is arranged inside an enclosure according to some embodiments of the disclosure.

### DETAILED DESCRIPTION

The embodiments described below are exemplary embodiments for promoting understanding of the disclosure, and it should be noted that the disclosure may be implemented while being modified in various forms, unlike the embodiments described herein. Meanwhile, in explaining the disclosure below, in case it is determined that detailed explanation of related known functions or components may unnecessarily confuse the gist of the disclosure, the detailed explanation and detailed illustration will be omitted. Also, in the accompanying drawings, some components may not be illustrated according to their actual sizes but they may be illustrated in exaggerated sizes, for promoting understanding of the disclosure.

In addition, as terms used in this specification and the claims, general terms were selected, in consideration of the functions described in the disclosure. However, the terms may vary depending on the intention of those skilled in the art, legal or technical interpretation, or emergence of new technologies, etc. Also, there are terms that were arbitrarily designated by the disclosure, and the meaning of such terms may be interpreted as defined in this disclosure. Terms that are not specifically defined in the disclosure may be interpreted based on the overall content of the disclosure and common technical knowledge in the pertinent art.

Further, in the description of the disclosure, the order of each step should be understood in a non-restrictive way, unless a preceding step should necessarily be performed prior to a subsequent step in a logical and temporal sense. That is, excluding an exceptional case as above, even if a process described as a subsequent step is performed prior to a process described as a preceding step, there would be no influence on the essence of the disclosure, and the scope of the disclosure should also be defined regardless of the orders of steps.

Also, in this disclosure, expressions such as “have,” “may have,” “include,” and “may include” denote the existence of such characteristics (e.g.: elements such as numbers, functions, operations, and components), and do not exclude the existence of additional characteristics.

In addition, terms such as ‘the first,’ ‘the second,’ etc. may be used to describe various elements, but the terms are not intended to limit the elements. The terms may be used only for the purpose of distinguishing one element from another element. For example, a first element may be called a second element, and a second element may be called a first element in a similar manner, without departing from the scope of the disclosure.

Further, terms such as ‘front surface,’ ‘rear surface,’ ‘top surface,’ ‘bottom surface,’ ‘side surface,’ ‘left side,’ ‘right side,’ ‘upper part,’ ‘lower part,’ and the like used in the disclosure were defined based on the drawings, and the shapes and locations of respective elements are not limited by these terms.

The term “at least one or ‘A’, ‘B’, and/or ‘C’” may refer to each and every combination of A, B and C. For example, “at least one of A, B, or C” may refer to only A, only B, only C, only A and B, only A and C, only B and C, or all of A, B, and C.

Also, in this disclosure, elements necessary for explanation of the embodiments of the disclosure are described, and thus elements are not necessarily limited thereto. Accordingly, some elements may be changed or omitted, or other elements may be added. In addition, elements may be arranged to be dispersed in devices independent from one another.

Further, while the embodiments of the disclosure will be described in detail with reference to the following accompanying drawings and the content described in the accompanying drawings, it is not intended that the disclosure is restricted or limited by the embodiments.

Hereinafter, the disclosure will be described in detail with reference to the accompanying drawings.

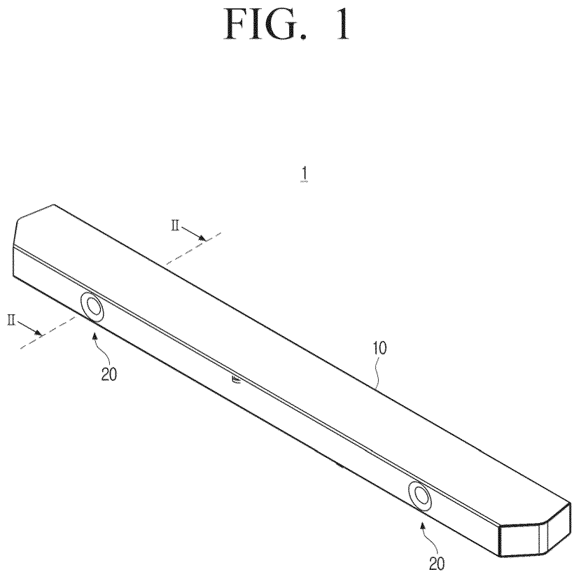

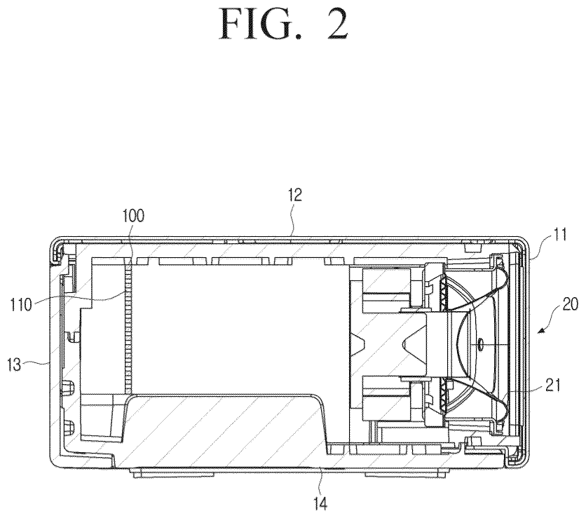

FIG. 1 is a perspective view illustrating an acoustic output device according to some embodiments of the disclosure, and FIG. 2 is a cross-sectional view that is cut along II-II in FIG. 1.

Referring to FIG. 1 or FIG. 2, an acoustic output device 1 according to an embodiment of the disclosure may include an enclosure 10, a speaker driver 20, and a filter 100.

The enclosure 10 may surround the speaker driver 20, and form the exterior of the acoustic output device 1. The enclosure 10 may fix the speaker driver 20.

The enclosure 10 may be formed in an approximately rectangular shape. That is, the enclosure 10 may be formed as a rectangular shape and may be hollow inside. Here, the speaker driver 20 may be fixed to the enclosure 10 such that a vibration plate 21 is exposed to the front surface 11 of the enclosure 10. The rear part of the speaker driver 20 is in a form of being enclosed by the enclosure 10.

The speaker driver 20 may include a vibration plate 21 generating sounds. The vibration plate 21 of the speaker driver 20 may be driven by various methods. For example, the speaker driver 20 may output sounds by vibrating the vibration plate 21 by using a magnet generating magnetic flux and a voice coil that moves as magnetic force is generated when power is applied.

The vibration plate 21 is formed to be able to reproduce sounds by vibration. As the material of the vibration plate 21, various materials may be used. For example, the vibration plate 21 may be manufactured by using paper, pulp, talc, mica, polypropylene, graphite, glass fiber, carbon, aluminum, etc.

The shape of the vibration plate 21 is not specifically limited. For example, the vibration plate 21 may be formed in one shape among a circle, an oval, a track form, or a quadrangle. Alternatively, the vibration plate 21 may also be formed as an amorphous shape.

Meanwhile, as the vibration plate 21 vibrates, sounds waves are generated in the front and rear directions, and a sound wave generated in the rear surface direction of the vibration plate 21 is reflected on the internal wall surface of the enclosure 10, and the reflected wave is overlapped with a sound wave generated in the front surface direction of the vibration plate 21 or is extinguished, and accordingly, a standing wave that reduces the performance of the acoustic output device 1 is generated. For removing a standing wave, energy of a reflected wave that is reflected from the inner surface of the enclosure 10 should be extinguished or lowered.

For this, in the acoustic output device 1 according to some embodiments of the disclosure, the filter 100 may be arranged in the inner space of the enclosure 10.

Referring to FIG. 2, the filter 100 may be arranged between the rear surface of the speaker driver 20 and the inner surface of the enclosure 10, and may include a plurality of through holes 110. The inner surface of the enclosure 10 may be open space of the inside area of the enclosure 10 between the filter 100 and the vibration plate 21.

The filter 100 may be arranged to be adjacent to the inner side of the rear surface 13 of the enclosure 10, and may proceed through the plurality of through holes 110 and reflect a reflected wave that was reflected on the rear surface 13 of the enclosure 10 to the side of the rear surface 13 again, and may thereby reduce the energy of the reflected wave. The filer 100 may be arranged closer the rear surface 13 of the enclosure 10 that the front surface 11 of the enclosure 10.

The filter 100 may be formed to have a size corresponding to the rear surface of the speaker driver 20.

Meanwhile, the filter 100 may be arranged to be distanced from the inner surface of the enclosure 10. The distance between the filter 100 and the inner surface of the enclosure 10 may be based on the distance between the rear surface of the speaker driver 20 and the inner surface of the enclosure 10.

Also, the upper part and the lower part of the filter 100 are fixed to the inner surface of the enclosure 10 and reinforce the stiffness of the enclosure 10, and accordingly, a bracing effect of reducing resonance phenomena of the enclosure 10 that may be generated as a sound is output by the speaker driver 20 can be exerted.

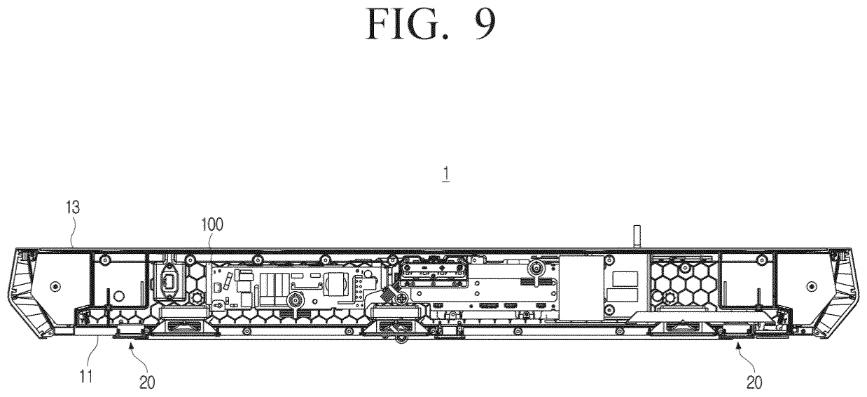

Also, the arrangement location of the filter 100 may not be limited to the rear surface part of the speaker driver 20, and the filter 100 may be installed in an area wherein a bracing effect or a resistance component of an air flow is required inside the enclosure 10. According to some embodiments, the filter 100 may be installed in an area wherein a big air flow is generated in the inner space of the enclosure 10, and resistance to the air flow may thereby be applied, and accordingly, damage that can occur according to the air flow can be prevented. Detailed explanation in this regard will be described later with reference to FIG. 9.

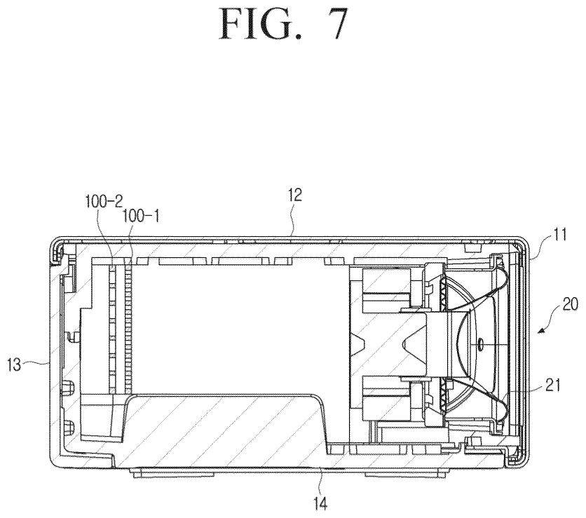

Meanwhile, the filter 100 may include a first filter and a second filter which are sequentially arranged between the rear surface of the speaker driver 20 and the inner surface of the enclosure 10, and which respectively include a plurality of through holes. In this case, at least one of the shapes or the arrangement of the plurality of through holes respectively formed on the first filter and the second filter may be different. Accordingly, an effect of removing a standing wave can be improved more than a case of arranging one filter or a plurality of filter members having the same shape. Detailed explanation in this regard will be described later with reference to FIG. 7.

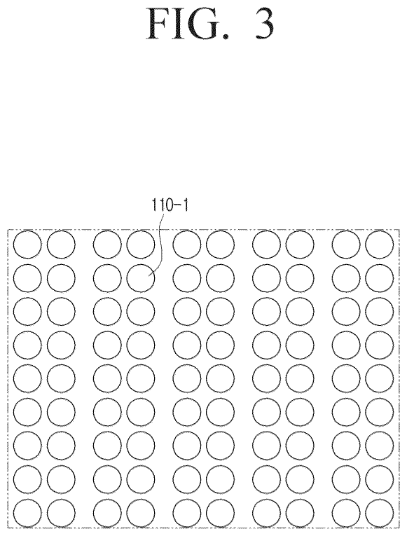

Hereinafter, various embodiments related to the form of the filter 100 will be described with reference to FIG. 3 to FIG. 6.

FIG. 3 to FIG. 6 are diagrams illustrating various embodiments related to shapes and an arrangement form of a plurality of through holes formed on a filter member.

The filter 100 may have a plate shape on which a plurality of through holes are formed. The plurality of through holes may be formed to penetrate the front and rear surfaces of the plate of the filter 100.

The plurality of through holes may have a shape of at least one of a circle, an oval, a polygon, and a polygon of which edges are round, and may be arranged in various ways. According to some embodiments, the plurality of through holes may be arranged in a matrix form wherein the through holes are regularly arranged along rows and columns.

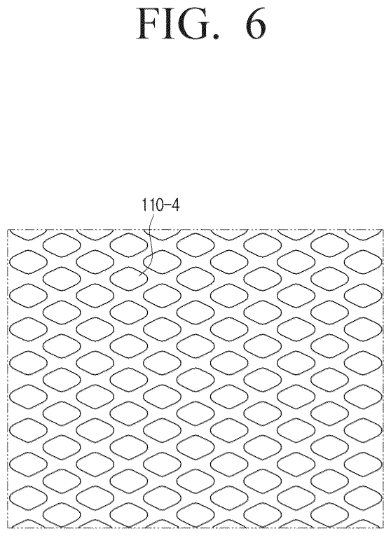

FIG. 3 and FIG. 6 respectively illustrate some embodiments of a filter having a plurality of circle through holes 110-1, and some embodiments of a filter having a plurality of rhombus through holes 110-4.

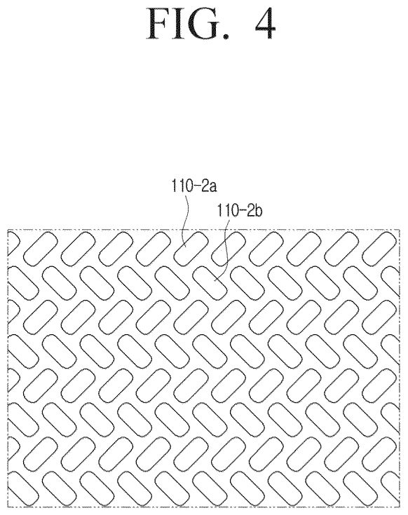

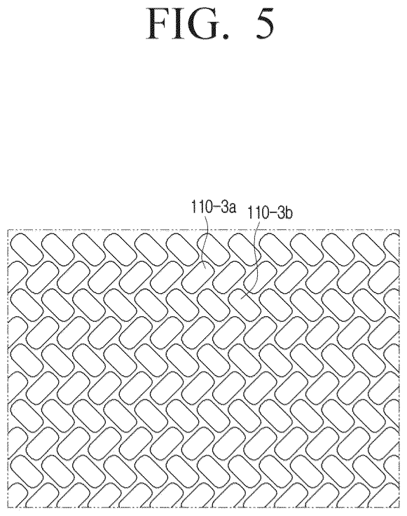

FIG. 4 and FIG. 5 illustrate various embodiments of a filter wherein rows arranged in different forms are arranged alternately along a column direction.

Referring to FIG. 4, the filter has a form wherein a plurality of through holes 110-2a having quadrangle forms tilted to one side are arranged along a row direction, and on the row below, a plurality of through holes 110-2b having quadrangle forms tilted to the other side are arranged along a row direction, and the two kinds of row arrangements are arranged alternately along a column direction.

Likewise, referring to FIG. 5, the filter has a form wherein a plurality of through holes 110-3a having polygon forms tilted to one side are arranged along a row direction, and on the row below, a plurality of through holes 110-3b having polygon forms tilted to the other side are arranged along a row direction, and the two kinds of row arrangements are arranged alternately along a column direction.

FIG. 7 is a diagram for illustrating an acoustic output device wherein two filter members are arranged according to some embodiments of the disclosure.

Referring to FIG. 7, a first filter 100-1 and a second filter 100-2 may be sequentially arranged between the rear surface of the speaker driver 20 and the inner surface of the enclosure 10.

The first filter 100-1 and the second filter 100-2 may respectively include a plurality of through holes, and the shapes or the arrangement form of the plurality of through holes formed on each filter may be different.

Accordingly, as the number of times of collision increases as a sound wave which is generated from the vibration plate 21 and proceeds to the inside of the enclosure 10 collides with the first filter 100-1, the second filter 100-2, and the inner surface of the enclosure 10, an effect of reducing energy of a reflected wave can be improved, and an effect of removing a standing wave can also be improved.

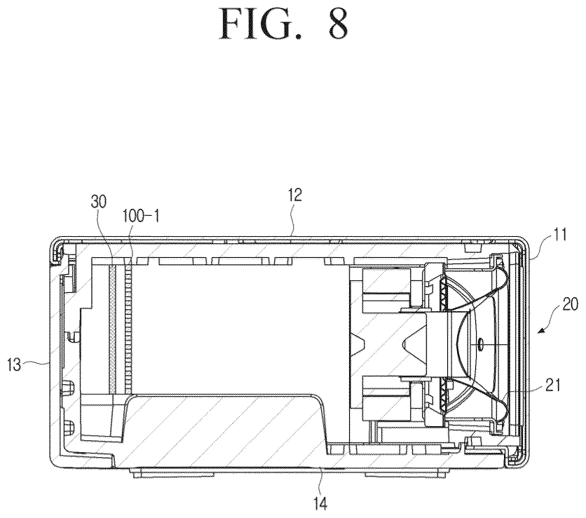

Meanwhile, in some embodiments of the disclosure, an effect of removing a standing wave can be further improved by adding a sound absorbing material. Referring to FIG. 8, as a sound absorbing material 30 is arranged on one surface of the filter 100, reflected waves that remained after colliding with the filter 100 and the inner surface of the enclosure 10 can be additionally absorbed.

FIG. 9 is a diagram for illustrating a structure wherein a filter is arranged inside an enclosure according to some embodiments of the disclosure. FIG. 9 is a diagram wherein the inner space of the enclosure 10 is viewed from the above. Referring to FIG. 9, the filter 100 may be arranged in the side surface space of the speaker driver 20 but not the rear surface part of the speaker driver 20. Accordingly, the stiffness of the enclosure 10 can be reinforced by supporting the inner space of the enclosure 10 by using the filter 100. Also, as resistance to an air flow is applied by arranging the filter 100 in an area wherein a resistance component of an air flow is required, damage inside the enclosure 10 that is generated according to the air flow can be prevented.

While example embodiments of the disclosure have been shown and described, the disclosure is not limited to the aforementioned specific embodiments, and it is to be understood that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

What is claimed is:

1. An acoustic output device comprising:
an enclosure;
a speaker driver arranged inside and fixed by the enclosure and comprising a vibration plate exposed to a front surface of the enclosure, the vibration plate being configured to generate sounds; and
a filter arranged between a rear surface of the speaker driver and an inner surface of the enclosure,
wherein the filter is distanced from the inner surface of the enclosure and comprises a plurality of through holes.

2. The acoustic output device of claim 1, wherein the filter further comprises a first filter and a second filter sequentially arranged between the rear surface of the speaker driver and the inner surface of the enclosure, and
wherein each of the first filter and the second filter respectively comprise a plurality of through holes.

3. The acoustic output device of claim 2, wherein at least one of a shape or an arrangement of the plurality of through holes of the first filter and the second filter are different.

4. The acoustic output device of claim 1, wherein the plurality of through holes have a shape of at least one of a circle, an oval, a polygon, or a polygon having round edges.

5. The acoustic output device of claim 1, wherein the plurality of through holes are arranged in a matrix form.

6. The acoustic output device of claim 1, wherein the enclosure is hollow and has a rectangular shape, and
wherein an upper part and a lower part of the filter are fixed to the inner surface of the enclosure.

7. The acoustic output device of claim 1, wherein the filter comprises a plate shape on which the plurality of through holes are formed, and
wherein the plurality of through holes penetrate a front surface and a rear surface of the filter.

8. The acoustic output device of claim 1, wherein the filter has a size corresponding to the rear surface of the speaker driver.

9. The acoustic output device of claim 1, further comprising: a sound absorbing material one surface of the filter.

10. The acoustic output device of claim 1, wherein a distance between the filter and the inner surface of the enclosure is based on a distance between the rear surface of the speaker driver and the inner surface of the enclosure.
